(19) United States
(12) Patent Application Publication
(10) Pub. No.: US 2026/0162986 A1
(43) Pub. Date: Jun. 11, 2026

(54) SULFIDE COATINGS ENABLING ULTRA-STABLE CATHODES OF BATTERIES

(71) Applicant: BOARD OF TRUSTEES OF THE UNIVERSITY OF ARKANSAS, Little Rock, AR (US)

(72) Inventors: Xiangbo Meng, Fayetteville, AR (US); Meetesh Singh, Fayetteville, AR (US)

(73) Assignee: BOARD OF TRUSTEES OF THE UNIVERSITY OF ARKANSAS, Little Rock, AR (US)

(21) Appl. No.: 19/411,784

(22) Filed: Dec. 8, 2025

Related U.S. Application Data
(60) Provisional application No. 63/729,352, filed on Dec. 7, 2024.

(51) Int. Cl. H01M 4/58; H01M 4/02; H01M 4/04; H01M 4/36; H01M 4/505; H01M 10/054

(52) U.S. Cl. CPC H01M 4/5815; H01M 4/0404; H01M 4/0428; H01M 4/366; H01M 4/505; H01M 10/054; H01M 2004/028

(57) ABSTRACT

The invention relates to a cathode that includes one or more sulfide-based layers positioned on a surface of the cathode, where the sulfide-based layer includes a plurality of stacked layers. The invention also relates to an energy storage device that includes such cathodes. The invention also relates to methods of forming a coated cathode by depositing one or more sulfide-based layers onto a surface of the cathode.

### CROSS-REFERENCE TO RELATED APPLICATIONS

This patent application claims priority from, and incorporates by reference the entire disclosure of, U.S. Provisional Patent Application No. 63/729,352, filed on Dec. 7, 2024

### BACKGROUND

Batteries suffer from numerous limitations, such as long-term cyclability, high sustainable capacity, and safety. Numerous embodiments of the present disclosure aim to address the aforementioned limitations.

### SUMMARY OF THE INVENTION

In some embodiments, the present disclosure pertains to a cathode that includes one or more sulfide-based layers positioned on a surface of the cathode. In some embodiments, the sulfide-based layer includes a plurality of stacked layers.

Additional embodiments of the present disclosure pertain to an energy storage device that includes a cathode of the present disclosure. In some embodiments, the energy storage device includes: a cathode, which includes sulfide-based layer with a plurality of stacked layers positioned on a surface; an electrolyte; and an anode.

Additional embodiments of the present disclosure pertain to methods of forming a coated cathode. Such methods generally include depositing one or more sulfide-based layers onto a surface of the cathode. In some embodiments, the depositing includes depositing one or more pre-formed sulfide-based layers onto the surface of the cathode. In some embodiments, the depositing includes forming one or more sulfide-based layers on the surface of the cathode. In some of such embodiments, the methods of the present include depositing a metal precursor and a sulfide precursor onto a surface of a cathode to form one or more sulfide-based layers on the cathode surface. In some embodiments, the method may be repeated multiple times to form multiple sulfide-based layers on the cathode surface. In some embodiments, the methods of the present disclosure also include a step of incorporating the cathode as a component of an energy storage device.

### BRIEF DESCRIPTION OF THE DRAWINGS

FIG. 1A provides an illustration of a cathode in accordance with various embodiments of the present disclosure.

FIG. 1B provides an illustration of a battery in accordance with various embodiments of the present disclosure.

FIG. 1C provides an illustration of a method of forming a coated cathode in accordance with various embodiments of the present disclosure.

FIGS. 2A-2C provide scanning electron microscopy (SEM) images of sodium manganese oxide (NMO) electrodes coated with different layers of sodium sulfide (Na₂S) through atomic layer deposition (ALD). Shown are bare (i.e., Na₂S-0) (FIG. 2A), 10-ALD-cycle Na₂S-coated (i.e., Na₂S-10) (FIG. 2B), and 40-ALD-cycle Na₂S-coated (i.e., Na₂S-40) (FIG. 2C) NMO electrodes.

FIG. 2D shows an energy dispersive Xray spectroscopy (EDS) elemental mapping of the Na₂S-10 electrode, showing conformal distribution of S (i.e., the ALD Na₂S coating) over the electrode.

FIGS. 3A-3E show electrochemical performance of bare and Na₂S-coated NMO cathodes. FIGS. 3A-3B show discharge (FIG. 3A) and charge (FIG. 3B) capacity of NMO electrodes with cycle number, tested at 0.2 C in the voltage window of 2-4 V. FIGS. 3C-3D show charge (FIG. 3C) and discharge capacity (FIG. 3D) of NMO electrodes under different current rates (0.1, 0.2, 0.5, 1.00, and 0.5 C), tested in the voltage window of 2-4 V. FIG. 3E shows a discharge capacity of NMO electrodes with cycle number, tested at 0.5 C in the voltage window of 2-4 V. 1 C=100 mA·g⁻¹ and the electrolyte is 1M NaClO₄ in propylene carbonate (PC). The results show that the Na₂S-10 (i.e., the NMO electrode coated by 10-ALD-cycle of Na₂S at 150° C.) performed best in all the cases.

FIGS. 4A-4D provide charge/discharge profiles of bare and Na₂S-coated NMO cathodes. The bare (FIG. 4A), Na₂S-10 (FIG. 4B), Na₂S-20 (FIG. 4C), and Na₂S-40 (FIG. 4D) NMO cathodes were tested at 0.5 C in the voltage window of 2-4 V (1 C=100 mA·g⁻¹). The electrolyte is 1M NaClO₄ in propylene carbonate (PC).

FIG. 5A-5D show SEM images of Na₂S-10 ALD cycled (FIGS. 5C-5D) and bare (FIGS. 5A-5B) NMO electrodes. The Na₂S-10 ALD cycled electrode is shown to have a thinner solid electrolyte interphase (SEI) layer.

FIGS. 6A-6B show in situ measurements of ALD Na₂S growth using quartz crystal microbalance (QCM), showing that the Na₂S growth is very linear and controllable at 150° C.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Lithium-ion batteries (LIBs) have received extensive applications in portable electronics, electric vehicles, and national grids. However, the limited natural abundance of Li has caused serious concerns about the sustainability of LIBs. Additionally, LIBs also have been exposed with safety and low-temperature performance issues.

Thus, a need exists to seek and develop alternative energy storage technologies that enable low cost, high natural abundance, and superior overall performance. To this end, sodium-ion batteries (SIBs) and sodium metal batteries (SMBs) are very promising. SIBs and SMBs typically consist of a cathode, an anode, a polymeric membrane, and an electrolyte between the cathode and anode. The cathode and anode are paired to generate a cell potential and store sodium-ions (Na⁺) during a charge/discharge process. The separator is used to physically separate the anode and cathode while the electrolyte is to facilitate the transport of Na⁺ between the anode and cathode internally during the charge/discharge process.

Sodium has a crustal abundance of 2.36%, which is about 1200 times larger than that of lithium. Thus, sodium-based batteries are more cost-effective and economically advantageous. Compared to LIBs, in addition, SIBs generally exhibit enhanced stability and safety under similar conditions. In SIBs and SMBs, cathodes take an important role in determining cell energy density, for they are determinant for cell voltage.

In SIBs, cathodes also serve as the source of active sodium-ions (Na⁺). Similar to LIB cathodes, there are many different types of cathodes in SIBs, such as oxides, phosphates, sulfates, silicates, borates, Prussian blue analogs, organic-based materials, and other compounds. Among these cathodes, oxide cathodes represent an important class and can be expressed as NaₓMO₂ (0<x≤1), where M is one or more of the 3d transition metal elements (such as Fe, Mn, Ni, Co, Cu, etc.). These oxide cathodes can feature high theoretical capacity, low cost, and facile synthesis. In SIBs and SMBs, however, they commonly suffer from a series of issues, including irreversible phase transitions, migration and dissolution of metal cations, loss of reactive oxygen, and side reactions at the cathode/electrolyte interface. To achieve long-term stable applications of SIBs and SMBs, it is imperative to address these issues.

In sum, batteries suffer from numerous limitations. For instance, sodium-based rechargeable batteries are advantageous due to their low cost and enhanced performance. However, the cathodes of sodium-based rechargeable batteries suffer from a series of issues that hamper their full potential, such as long-term cyclability, high sustainable capacity, and safety. Numerous embodiments of the present disclosure aim to address the aforementioned limitations.

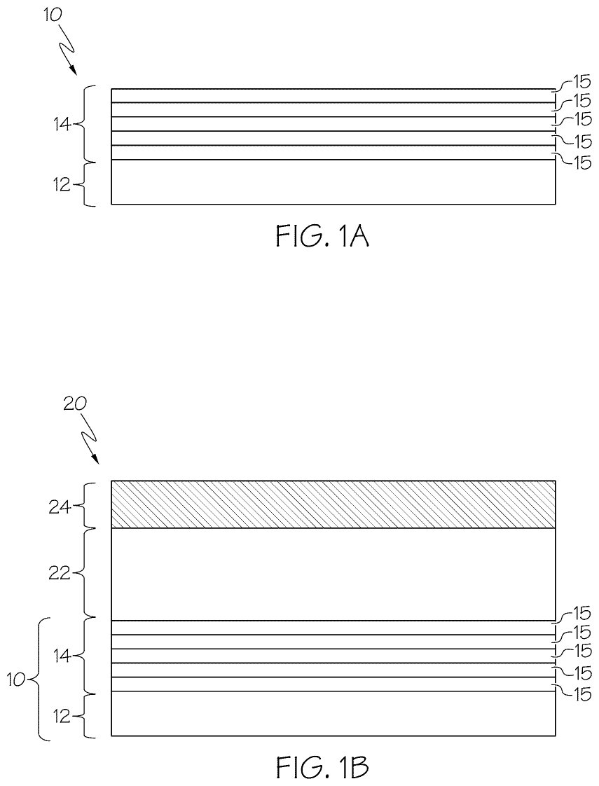

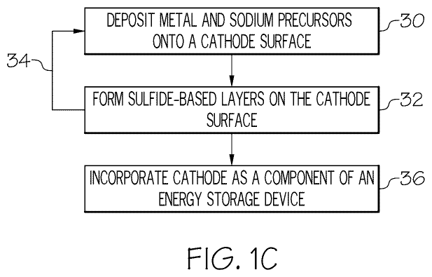

In some embodiments, the present disclosure pertains to a cathode that includes one or more sulfide-based layers positioned on a surface of the cathode. With reference to cathode 10 in FIG. 1A for illustrative purposes, cathode 10 may include a sulfide-based layer 14 positioned on surface 12, where sulfide-based layer 14 includes a plurality of stacked layers 15.

Additional embodiments of the present disclosure pertain to an energy storage device that includes a cathode of the present disclosure. With reference to energy storage device 20 in FIG. 1B for illustrative purposes, energy storage device 20 includes: cathode 10, which includes sulfide-based layer 14 with a plurality of stacked layers 15 positioned on surface 12 of the cathode, electrolyte 22, and anode 24.

Additional embodiments of the present disclosure pertain to methods of forming a coated cathode. Such methods generally include depositing one or more sulfide-based layers onto a surface of the cathode. In some embodiments, the depositing includes depositing one or more pre-formed sulfide-based layers onto the surface of the cathode. In some embodiments, the depositing includes forming one or more sulfide-based layers on the surface of the cathode. In some of such embodiments illustrated in FIG. 1C, the methods of the present include depositing a metal precursor and a sulfide precursor onto a surface of a cathode (step 30) to form one or more sulfide-based layers on the cathode surface (step 32). In some embodiments, the method may be repeated multiple times to form a plurality of stacked sulfide-based layers on the cathode surface (step 34). In some embodiments, the methods of the present disclosure also include a step of incorporating the cathode as a component of an energy storage device (step 36).

As set forth in more detail herein, the cathodes, energy storage devices and methods of the present disclosure can have numerous embodiments.

### Cathodes

The cathodes of the present disclosure may be in various forms. Additionally, the methods of the present disclosure may be utilized to form various cathodes. Moreover, the energy storage devices of the present disclosure may include various types of cathodes.

For instance, in some embodiments, the cathode includes, without limitation, oxide cathodes, phosphates, sulfates, silicates, borates, Prussian blue analogs, organic-based materials, or combinations thereof.

In some embodiments, the cathode includes oxide cathodes. In some embodiments, the oxide cathode includes NaₓMO₂. In some embodiments, x is 0<x≤1. In some embodiments, M includes, without limitation, 3d transition metal elements, Fe, Mn, Ni, Co, Cu, or combinations thereof.

In some embodiments, the oxide cathode includes sodium manganese oxide cathodes. In some embodiments, the oxide cathode includes Na_{0.44}MnO₂.

### Sulfide-Based Layers

The cathodes of the present disclosure may include various sulfide-based layers. Additionally, the methods of the present disclosure may be utilized to form various types of sulfide-based layers on cathode surfaces.

For instance, in some embodiments, the sulfide-based layers include a metal sulfide. In some embodiments, the metal sulfide includes, without limitation, Li₂S, K₂S, Rb₂S, Cs₂S, Fr₂S, BeS, MgS, SrS, BaS, RaS, Sc₂S₃, Y₂S₃, TiS₂, ZrS₂, HfS₂, V₂S₅, Nb₂S₅, Ta₂S₅, CrS₂, MoS₂, WS₂, MnS, MnS₂, TcS₂, ReS₂, Fe₂S₃, Ru₂S₃, Os₂S₃, CoS, CoS₂, Co₃S₄, Co₉S₈, RhS, RhS₂, NiS, NiS₂, PdS, PdS₂, PtS, PtS₂, CuS, Cu₂S, Ag₂S, AgS, Au₂S, AuS, ZnS, CdS, HgS, B₂S₃, Al₂S₃, Ga₂S₃, In₂S₃, SiS, SiS₂, GeS, GeS₂, SnS, SnS₂, PbS, PbS₂, P₂S₅, As₂S₅, Sb₂S₅, Bi₂S₅, or combinations thereof.

In some embodiments, the sulfide-based layers include Na₂S. In some embodiments, the cathode includes NaₓMO₂, and the sulfide-based layers include Na₂S.

The sulfide-based layers of the present disclosure may be in various forms. For instance, in some embodiments, the sulfide-based layers are in the form of a film, nanoparticles, or combinations thereof.

In some embodiments, the sulfide-based layers of the present disclosure include multiple stacked layers. For instance, in some embodiments, the sulfide-based layers include at least 50 stacked layers. In some embodiments, the sulfide-based layers include at least 100 stacked layers.

In some embodiments, the sulfide-based layers include at least 150 stacked layers.

The methods of the present disclosure may deposit sulfide-based layers onto cathode surfaces in various manners. For instance, in some embodiments, the sulfide-based layers are deposited through atomic layer deposition (ALD). In some embodiments, the depositing includes depositing one or more pre-formed sulfide-based layers onto a surface of a cathode.

In some embodiments, the depositing includes forming one or more sulfide-based layers on a surface of a cathode. In some embodiments, sulfide-based layer formation includes depositing a metal precursor and a sulfide precursor onto a surface of a cathode.

In some embodiments, the metal precursor includes a sodium precursor. In some embodiments, the sodium precursor includes, without limitation, sodium tert-butoxide (NaO^{t}Bu), sodium trimethylsilanolate (NaOSiMe₃), Na(thd) (thd=2,2,6,6-tetramethyl-3,5-heptanedionate) or combinations thereof.

In some embodiments, the sodium precursor includes sodium tert-butoxide (NaOtBu). In some embodiments, the sulfide precursor includes hydrogen sulfide (H₂S).

In some embodiments, metal precursors and sulfide precursors are deposited on a cathode surface through atomic layer deposition (ALD). In some embodiments, the depositing is repeated multiple times to form at least 50 stacked layers of the sulfide-based layer. In some embodiments, the depositing is repeated multiple times to form at least 100 stacked layers of the sulfide-based layer. In some embodiments, the depositing is repeated multiple times to form at least 150 stacked layers of the sulfide-based layer.

### Energy Storage Devices

The cathodes of the present disclosure may be incorporated as components of various energy storage devices. For instance, in some embodiments, the energy storage device is a battery.

In some embodiments, the battery includes sodium-based batteries. In some embodiments, the sodium-based battery includes, without limitation, sodium metal batteries (SMBs), sodium ion batteries (SIBs), solid-state sodium batteries, or combinations thereof.

The batteries of the present disclosure may include various components. For instance, in some embodiments, the batteries (e.g., sodium-based batteries) of the present disclosure include: an anode, an electrolyte, and a cathode of the present disclosure. In some embodiments, the anode includes, without limitation, sodium metal anodes, hard carbon, tin-based anodes, phosphorous-based anodes, antimony-based anodes, oxide-based anodes, or combinations thereof. In some embodiments, the electrolytes include, without limitation, sodium salts, ionic liquids, solid-state electrolytes, gel polymer electrolytes, sulfide-based electrolytes, or combinations thereof.

### ADDITIONAL EMBODIMENTS

Reference will now be made to more specific embodiments of the present disclosure and experimental results that provide support for such embodiments. However, Applicant notes that the disclosure below is for illustrative purposes only and is not intended to limit the scope of the claimed subject matter in any way.

### Example 1. Sulfide Coatings Enabling Ultra-Stable Cathodes of Sodium Batteries

Several strategies have been widely practiced for addressing the issues of oxide cathodes of sodium ion batteries (SIBs) and sodium metal batteries (SMBs), including element doping, surface coating, structural design, and electrolyte optimization. Among them, surface coating is a facile and effective route. To date, several coating categories have been reported, including metal oxides (e.g., Al₂O₃, MgO, TiO₂, and ZrO₂), ionically conductive materials (e.g., NaPO₃, NaCaPO₄, NaTi₂(PO₄)₃, and NaSiO₃), and conductive polymers. However, to Applicant's knowledge, no sulfide materials as coatings have been reported in the literature.

One main hindrance for sulfides as coating films is that most of sulfides are not air-stable but are prone to react with oxygen and water. In this Example, Applicant reports for the first time that sulfides can be an important class of coating materials for SIBs and SMBs.

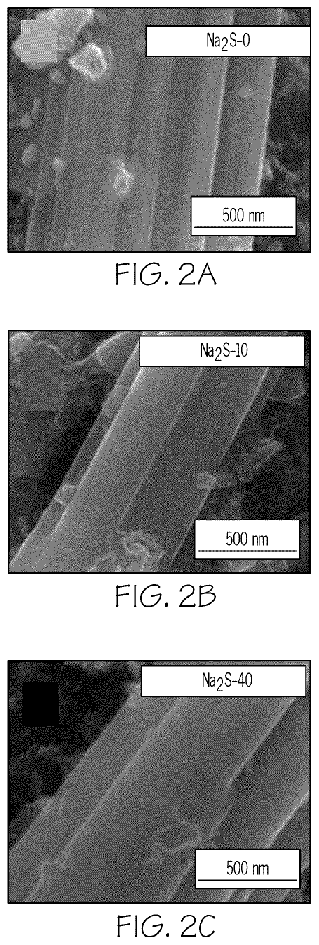

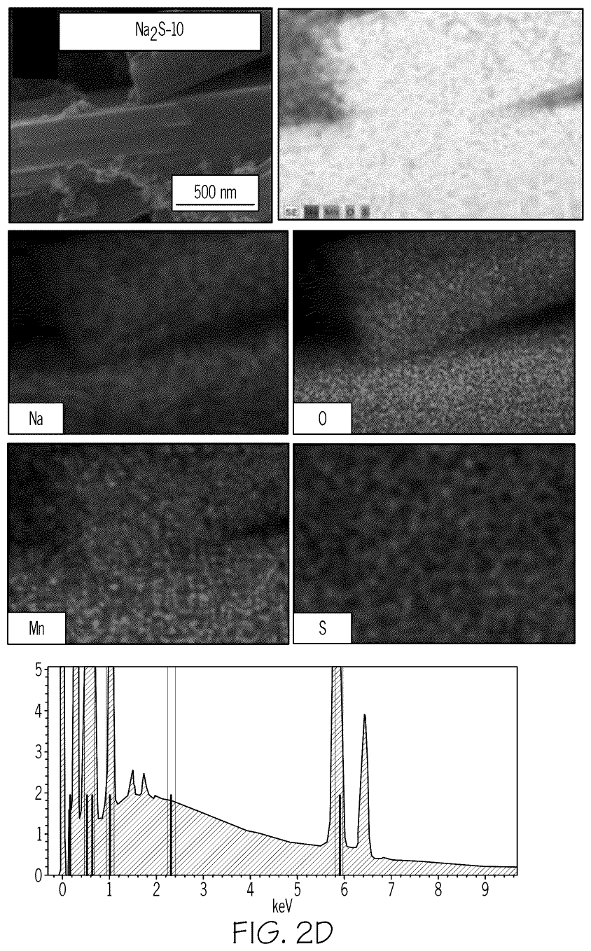

To demonstrate Applicant's discovery, Applicant coated a sodium sulfide (Na₂S) thin film over a sodium manganese oxide (NMO) cathode (i.e., Na_{0.44}MnO₂) and revealed the remarkably improved performance of the Na₂S-coated NMO cathode. The Na₂S coating was deposited on the Na_{0.44}MnO₂ cathode conformally by a thin film technique of atomic layer deposition (ALD) (FIGS. 2A-2D).

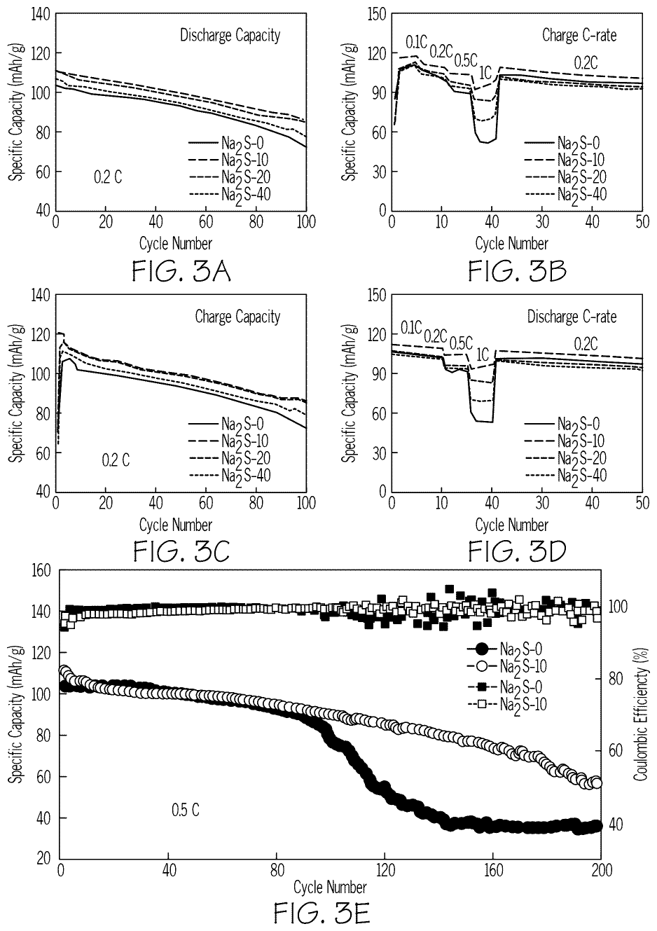

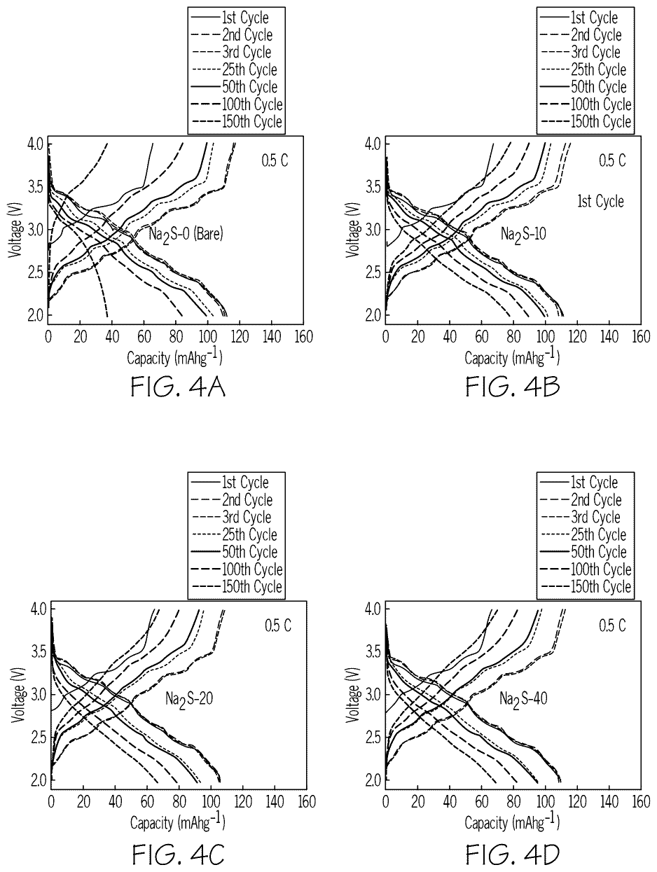

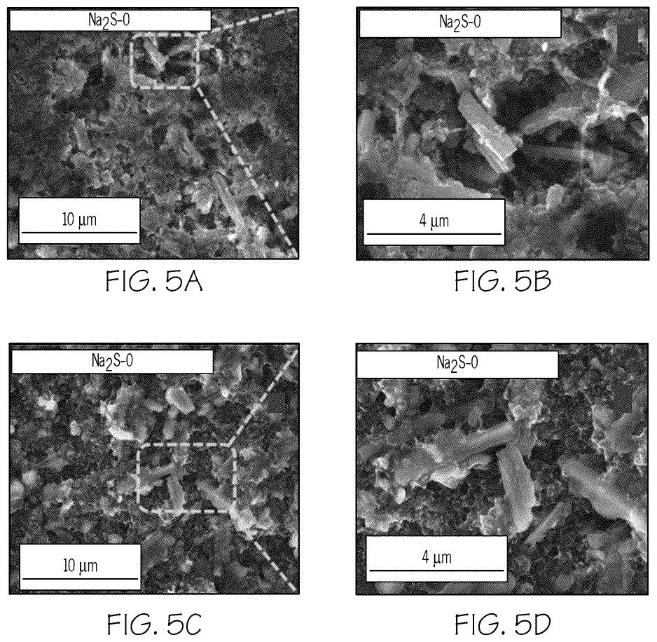

The Na₂S-coated NMO cathode exhibited remarkable improvement in capacity retention, rate capability, and long-term cyclability (FIGS. 3A-3E and 4A-4D). The Na₂S-coated NMO cathode also showed much less generation of solid electrolyte interphase (SEI) (FIGS. 5A-5D). The Na₂S coating was verified for beneficial effects in three aspects: (1) improve the mechanical integrity of the NMO electrode and NMO powders themselves; (2) stabilize the interface between the NMO electrode and its electrolyte; (3) mitigate the structural phase transition of NMO materials; and (4) protect electrolytes from oxidation and mitigate side reactions at the cathode/electrolyte interface.

### Example 1.1. Electrode Preparation

The NMC811 electrode laminates in this study contain 80 wt. % Na_{0.44}MnO₂ (NMO) powder (NEI Corporation), 10 wt. % polyvinylidene fluoride (PVDF, HSV900, MTI Corporation), and 10 wt. % carbon black (Timical super C₆₅). To fabricate the laminates, a slurry was first prepared by mixing NMC811 powders, PVDF, and carbon black with a suitable amount of 1-Methyl-2-pyrrolidinone (NMP, 99.5%, Sigma-Aldrich) homogenously. Then, the slurry was coated on Al foils. The resultant NMO laminates were fully dried in air first and then in vacuum at 100° C. for 10 hrs. The mass loading of the prepared NMO is ˜7.0 mg cm⁻².

### Example 1.2. Na₂S ALD Coating

To Applicant's knowledge, the Na₂S ALD process has not been reported in the literature. In this Example, the Na₂S coating was deposited on NMO laminates at 150° C. using an ALD system (Savannah 200, Cambridge Nanotech Inc., USA) integrated with an Ar-filled glove box. This integrated ALD-glove box facility guaranteed no air-exposure to the Na₂S-coated NMO laminates. The Na₂S ALD was proceeded using sodium tert-butoxide (STB, 98 at. %, Strem Chemicals, Inc.) and hydrogen sulfide (H₂S, 4 at. % in Argon, Airgas) as precursors. Ar was used as the carrier gas of the ALD precursors. To provide sufficient vapor pressure, the solid LTB was heated to 150° C. in a stainless steel bubbler.

A single ALD cycle was performed with four successive steps: (1) a 3.0 s dose of STB; (2) a 10.0 s purge using Ar gas to remove excessive LTB and byproducts; (3) a 3 s dose of H₂S, and (4) a 10.0 s purge using Ar gas to remove excessive H₂S and byproducts. NMO electrodes were coated with different ALD cycles: 10, 20, and 40 ALD cycles for different coating thicknesses. To facilitate identifying the different coated electrodes, the resultant ALD coated electrodes were denoted as Na₂S-10, Na₂S-20, and Na₂S-40, respectively. Accordingly, the bare (uncoated) NMC811 electrode was signified as Na₂S-0.

### Example 1.3. Materials Characterization

NMO electrodes were observed for morphological characteristics and element distribution, using a scanning electron microscopy (SEM) equipped with an energy dispersive Xray spectroscopy (EDS).

### Example 1.4. Electrochemical Measurements

Coin cells were assembled in the Ar-filled glove box after NMO laminates were coated with the ALD Na₂S film. In the glove box, oxygen and water were controlled less than 0.01 ppm. Sodium (Na) metal and Celgard 2325 membranes were used as the anode and the separator, respectively. The electrolyte was composed of 1M NaClO₄ in propylene carbonate (PC). All the assembled cells were rested for 10 hours prior to their electrochemical tests at room temperature. Galvanostatic charge-discharge was carried out using a Neware battery test system. The cells were cycled different rates, such as 0.2, 0.5, and 1 C (1 C=100 mA·g⁻¹), via a constant current (CC) mode in the voltage ranges of 2.0-4.0 versus Na/Na⁺.

### Example 1.5. Proof of Concept

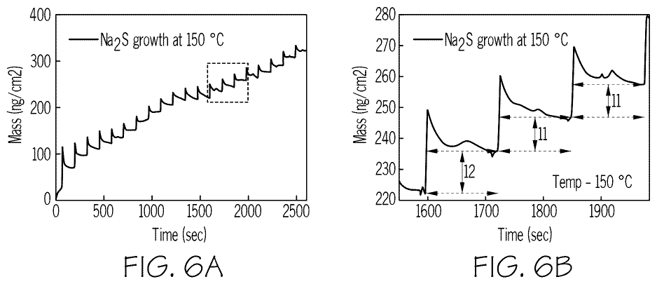

The effects of the ALD Na₂S coatings on prefabricated NMO electrodes at 150° C. were visualized (FIGS. 2A-2D). Applicant verified the feasibility of the proposed ALD process using in situ quartz crystal microbalance (QCM) measurements. In situ QCM measurements showed a linear and controllable growth (FIGS. 6A-6B). Using SEM and EDS, the resultant Na₂S-coated NMO electrodes (e.g., Na₂S-10 in FIG. 2B and Na₂S-40 in FIG. 2C) were confirmed with a conformal and uniform coating of Na₂S (FIG. 2D). The Na₂S-coated NMO electrodes were comparatively investigated with bare NMO electrodes (Na₂S-0).

As shown in FIGS. 3A-3E, the Na₂S-coated NMO cathodes exhibited better performance in sustainable capacity (FIGS. 3A-3C), long-term cyclability (FIGS. 3A-3C), and rate capability (FIG. 3E). FIGS. 4A-4D illustrate the charge/discharge profiles of NMO cathodes with/without an Na₂S coating, showing that the Na₂S coating is beneficial for improving the performance of NMO electrodes. All these results commonly showed that the Na₂S-10 cathode performed best. In other words, a 10-ALD-cycle Na₂S coating could help NMO electrodes to achieve the best electrochemical performance and is the optimal coating thickness.

Applicant further observed the cycled bare (Na₂S-0, FIGS. 5A-5B) and Na₂S-10 (Na₂S-0, FIGS. 4C-4D) NMO cathodes using SEM and found a thicker SEI formation over the cycled bare electrode (FIGS. 5A-5B). This evidenced that the Na₂S coating mitigated undesirable reactions.

To summarize, the ALD Na₂S coating has clearly demonstrated significant effects on improving the performance of NMO cathodes. The beneficial effects lie in multiple aspects, including improved mechanical integrity of electrodes, reduced microcracking, reduced side reactions, and mitigated phase transitions. This Na₂S coating represents the first effort using sulfides as coatings for SIB and SMB cathodes. Potentially, any sulfides potentially are beneficial to NMO cathodes as well as other SIB/SMB cathodes, such as Li₂S, K₂S, Rb₂S, Cs₂S, Fr₂S, BeS, MgS, SrS, BaS, RaS, Sc₂S₃, Y₂S₃, TiS₂, ZrS₂, HfS₂, V₂S₅, Nb₂S₅, Ta₂S₅, CrS₂, MoS₂, WS₂, MnS, MnS₂, TcS₂, ReS₂, Fe₂S₃, Ru₂S₃, Os₂S₃, CoS, CoS₂, Co₃S₄, Co₉S₈, RhS, RhS₂, NiS, NiS₂, PdS, PdS₂, PtS, PtS₂, CuS, Cu₂S, Ag₂S, AgS, Au₂S, AuS, ZnS, CdS, HgS, B₂S₃, Al₂S₃, Ga₂S₃, In₂S₃, SiS, SiS₂, GeS, GeS₂, SnS, SnS₂, PbS, PbS₂, P₂S₅, As₂S₅, Sb₂S₅, Bi₂S₅, and their mixtures and compounds.

Furthermore, this Example is not limited to the NMO and oxide cathodes. This Example predicts that sulfides can be effective to other cathode materials, including phosphates, sulfates, silicates, borates, Prussian blue analogs, organic-based materials, and other compounds.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein

1. A cathode comprising one or more sulfide-based layers positioned on a surface of the cathode.

2. The cathode of claim 1, wherein the cathode comprises an oxide cathode.

3. The cathode of claim 2, wherein the oxide cathode comprises NaₓMO₂,
wherein x is 0<x≤1, and
wherein M is selected from the group consisting of 3d transition metal elements, Fe, Mn, Ni, Co, Cu, or combinations thereof.

4. The cathode of claim 2, wherein the oxide cathode comprises sodium manganese oxide cathodes.

5. The cathode of claim 1, wherein the sulfide-based layers comprise a metal sulfide.

6. The cathode of claim 5, wherein the metal sulfide is selected from the group consisting of Li₂S, K₂S, Rb₂S, Cs₂S, Fr₂S, BeS, MgS, SrS, BaS, RaS, Sc₂S₃, Y₂S₃, TiS₂, ZrS₂, HfS₂, V₂S₅, Nb₂S₅, Ta₂S₅, CrS₂, MoS₂, WS₂, MnS, MnS₂, TcS₂, ReS₂, Fe₂S₃, Ru₂S₃, Os₂S₃, CoS, CoS₂, Co₃S₄, Co₉S₈, RhS, RhS₂, NiS, NiS₂, PdS, PdS₂, PtS, PtS₂, CuS, Cu₂S, Ag₂S, AgS, Au₂S, AuS, ZnS, CdS, HgS, B₂S₃, Al₂S₃, Ga₂S₃, In₂S₃, SiS, SiS₂, GeS, GeS₂, SnS, SnS₂, PbS, PbS₂, P₂S₅, As₂S₅, Sb₂S₅, Bi₂S₅, or combinations thereof.

7. The cathode of claim 5, wherein the metal sulfide comprises Na₂S.

8. The cathode of claim 1, wherein the cathode comprises NaₓMO₂, and wherein the sulfide-based layers comprises Na₂S, wherein x is 0<x≤1, and wherein M is selected from the group consisting of 3d transition metal elements, Fe, Mn, Ni, Co, Cu, or combinations thereof.

9. The cathode of claim 1, wherein the sulfide-based layers comprise a plurality of stacked layers.

10. The cathode of claim 1, wherein the sulfide-based layers are deposited through atomic layer deposition (ALD).

11. An energy storage device comprising a cathode, wherein the cathode comprises one or more sulfide-based layers positioned on a surface of the cathode.

12. The energy storage device of claim 11, wherein the energy storage device is a battery.

13. The energy storage device of claim 12, wherein the battery comprises a sodium-based battery selected from the group consisting of sodium metal batteries (SMBs), sodium ion batteries (SIB), solid-state sodium batteries, or combinations thereof.

14. The energy storage device of claim 11, wherein the cathode comprises an oxide cathode comprising NaₓMO₂,
wherein x is 0<x≤1, and
wherein M is selected from the group consisting of 3d transition metal elements, Fe, Mn, Ni, Co, Cu, or combinations thereof.

15. The energy storage device of claim 14, wherein the oxide cathode comprises sodium manganese oxide cathodes.

16. The energy storage device of claim 11, wherein the sulfide-based layers comprise a metal sulfide selected from the group consisting of Li₂S, K₂S, Rb₂S, Cs₂S, Fr₂S, BeS, MgS, SrS, BaS, RaS, Sc₂S₃, Y₂S₃, TiS₂, ZrS₂, HfS₂, V₂S₅, Nb₂S₅, Ta₂S₅, CrS₂, MoS₂, WS₂, MnS, MnS₂, TcS₂, ReS₂, Fe₂S₃, Ru₂S₃, Os₂S₃, CoS, CoS₂, Co₃S₄, Co₉S₈, RhS, RhS₂, NiS, NiS₂, PdS, PdS₂, PtS, PtS₂, CuS, Cu₂S, Ag₂S, AgS, Au₂S, AuS, ZnS, CdS, HgS, B₂S₃, Al₂S₃, Ga₂S₃, In₂S₃, SiS, SiS₂, GeS, GeS₂, SnS, SnS₂, PbS, PbS₂, P₂S₅, As₂S₅, Sb₂S₅, Bi₂S₅, or combinations thereof.

17. The energy storage device of claim 11, wherein the cathode comprises NaₓMO₂, and wherein the sulfide-based layers comprise Na₂S, wherein x is 0<x≤1, and wherein M is selected from the group consisting of 3d transition metal elements, Fe, Mn, Ni, Co, Cu, or combinations thereof.

18. The energy storage device of claim 11, wherein the sulfide-based layers comprise a plurality of stacked layers.

19. A method of forming a coated cathode, said method comprising:
depositing one or more sulfide-based layers onto a surface of the cathode.

20. The method of claim 19, wherein the depositing comprises depositing one or more pre-formed sulfide-based layers onto the surface of the cathode.

21. The method of claim 19, wherein the depositing comprises forming one or more sulfide-based layers on the surface of the cathode.

22. The method of claim 21, wherein the forming comprises depositing a metal precursor and a sulfide precursor onto the surface of the cathode.

23. The method of claim 22, wherein the metal precursor comprises a sodium precursor selected from the group consisting of sodium tert-butoxide (NaO^{t}Bu), sodium trimethylsilanolate (NaOSiMe₃), Na(thd) (thd=2,2,6,6-tetramethyl-3,5-heptanedionate), or combinations thereof.

24. The method of claim 22, wherein the sulfide precursor comprises hydrogen sulfide (H₂S).

25. The method of claim 22, wherein the metal precursor and the sulfide precursor are deposited through atomic layer deposition (ALD).

26. The method of claim 19, wherein the depositing is repeated multiple times to form a plurality of stacked layers of the sulfide-based layers.

27. The method of claim 19, further comprising a step of incorporating the cathode as a component of an energy storage device.
